(19) United States
(12) Patent Application Publication
(10) Pub. No.: US 2013/0262729 A1
(43) Pub. Date: Oct. 3, 2013

(54) SYSTEM AND METHOD FOR FILE SHARING

(71) Applicants: Che-Ya Chang, Hsinchu City (TW); Wen-Shih Liang, Hsinchu City (TW); Fu-Kuei Hsu, Hukou Township (TW)

(72) Inventors: Che-Ya Chang, Hsinchu City (TW); Wen-Shih Liang, Hsinchu City (TW); Fu-Kuei Hsu, Hukou Township (TW)

(73) Assignee: MODIOTEK CO., LTD., Hsinchu (TW)

(21) Appl. No.: 13/552,956

(22) Filed: Jul. 19, 2012

Related U.S. Application Data
(60) Provisional application No. 61/619,489, filed on Apr. 3, 2012.

(51) Int. Cl. G06F 13/36

(52) U.S. Cl. 710/302

(57) ABSTRACT

A system for file sharing includes a file integration service program and a dongle device. The file integration service program is installed in a first electrical device and provides to-be-shared files accessible by the first electrical device. The dongle device includes a hot-plug port, a microcontroller and a wireless communication module. The hot-plug port is for coupling to a second electrical device. When the hot-plug port is coupled to the second electrical device, the microcontroller disassembles and packages a first instruction with a SCSI standard from the second electrical device into the first instruction with a wireless communication standard. The wireless communication module transmits the first instruction with the wireless communication standard to the first electrical device, so that the second electrical device can access the to-be-shared files via the dongle device.

This application claims the benefit of U.S. provisional application Ser. No. 61/619,489, filed Apr. 3, 2012, the subject matter of which is incorporated herein by reference.

### BACKGROUND

1. Technical Field

The invention relates in general to a system and a method for file sharing.

2. Background

Legacy devices, such as home audio and video equipments, portable stereos or car audio and video equipments, usually only have USB ports without network accessing abilities and DLNA accessing abilities. Consequently, the legacy devices are hard to apply to modern popular smart devices or cloud storage media. Users have to copy files to USB disks and inserts the USB disks into the legacy devices, and then the legacy devices can access the files in the smart devices or the cloud storage media. The procedure is troublesome.

### SUMMARY

The disclosure is directed to a system and a method for file sharing, utilizing a dongle device and a file integration service program to make legacy devices be able to easily access files in remote storage media.

According to a first aspect of the present disclosure, a system for file sharing is provided. The system for file sharing includes a file integration service program and a dongle device. The file integration service program is installed in a first electrical device and provides a file allocation table corresponding to multiple to-be-shared files accessible by the first electrical device. The dongle device includes a hot-plug port, a microcontroller and a wireless communication module. The hot-plug port is for coupling to a second electrical device. When the hot-plug port is coupled to the second electrical device, the microcontroller disassembles and packages a first instruction with a SCSI standard from the second electrical device into the first instruction with a wireless communication standard. The wireless communication module transmits the first instruction with the wireless communication standard to the first electrical device, so that the second electrical device can access the to-be-shared files via the dongle device.

According to a second aspect of the present disclosure, a method for file sharing is provided. The method for file sharing includes the following steps. A file integration service program, installed in a first electrical device, is utilized to provide a file allocation table corresponding to multiple to-be-shared files accessible by the first electrical device. A hot-plug port of a dongle device is utilized to couple to a second electrical device. A microcontroller of the dongle device is utilized to disassemble and package a first instruction with a small computer system interface (SCSI) standard from the second electrical device into the first instruction with a wireless communication standard when the hot-plug port is coupled to the second electrical device. A wireless communication module of a dongle device is utilized to transmit the first instruction with the wireless communication to the first electrical device, so that the second electrical device can access the to-be-shared files according to the file allocation table via the dongle device.

The invention will become apparent from the following detailed description of the preferred but non-limiting embodiments. The following description is made with reference to the accompanying drawings.

### BRIEF DESCRIPTION OF THE DRAWINGS

FIG. 1 shows a schematic illustration of a system for file sharing according to an embodiment.

FIG. 2 shows a schematic illustration of operations of a file integration file program according to an embodiment.

### DETAILED DESCRIPTION OF THE INVENTION

The disclosure proposes a system and a method for file sharing. A dongle device and a file integration service program are utilized to make legacy devices be able to easily access files in remote storage media.

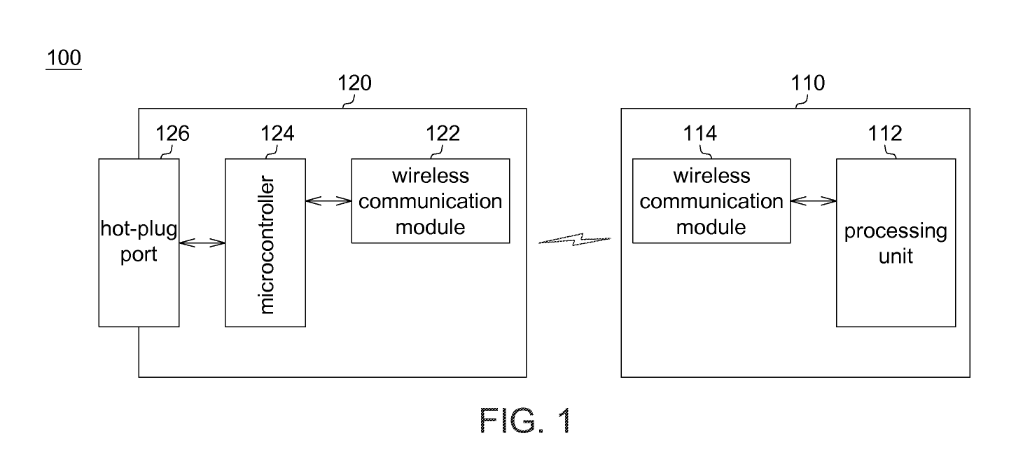

Referring to FIG. 1, a schematic illustration of a system for file sharing according to an embodiment is shown. The system for file sharing 100 includes a file integration service program and a dongle device 120. The file integration service program is installed in a first electrical device 110. The first electrical device 110 is, for example, a smart device, such as smart phones, tablets, notebooks or PCs, but it is not limited thereto. And the file integration service program is substantially an application (App) installable in the smart device. The first electrical device 110 has network accessing abilities and higher computing capabilities and file processing abilities than legacy devices. The legacy devices are devices having hot-plug interfaces, such as universal serial bus (USB) interfaces or a 1394 port without limitation, but having none or limited network accessing abilities, such as home audio and video equipments, portable stereos or car audio and video equipments, but it is not limited thereto.

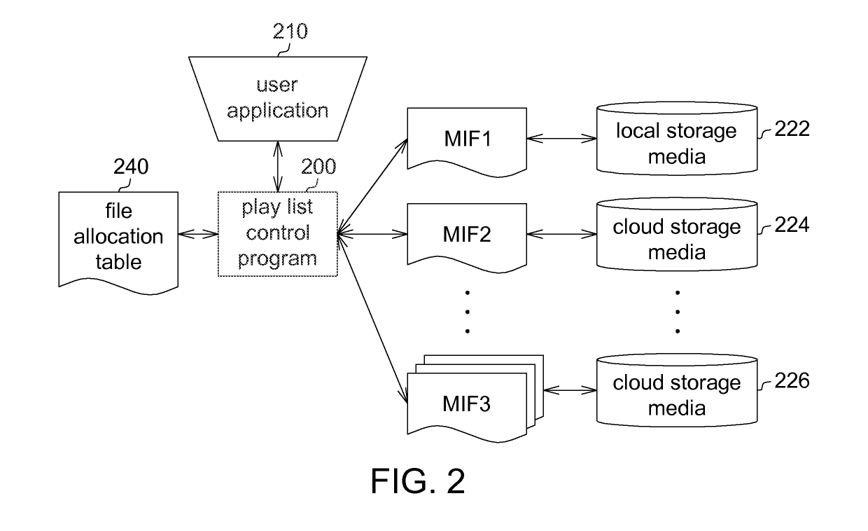

Referring to FIG. 2, a schematic illustration of operations of a file integration file program according to an embodiment is shown. The file integration service program takes a play list control program 200 as a kernel to select multiple to-be-shared files MIF1 to MIF3 accessible by the first electrical device 110, and then maps the to-be-shared files MIF1 to MIF3 and corresponding lists to a file allocation table 240. The file allocation table 240 is, for example, a virtual storage image. The to-be-shared files MIF1 to MIF3 are stored in media accessible by the first electrical device 110, such as a local storage media, a cloud storage media or a network streaming media, but it is not limited thereto.

The dongle device 120 includes a wireless communication module 122, a microcontroller 124 and a hot-plug port 126. The wireless communication module 122 communicates with the first electrical device 110 according to a wireless communication standard, such as Bluetooth or WiFi, but it is not limited thereto. The hot-plug port 126, such as a USB port or a 1394 port without limitation, is for coupling to a second electrical device (not shown in the figure). When the hot-plug port 126 is coupled to the second electrical device, the microcontroller 124 executes firmware stored in a flash for example, and disassembles and packages a first instruction with a small computer system interface (SCSI) from the second electrical device into the first instruction with the wireless communication standard.

The wireless communication module 122 transmits the first instruction with the wireless communication standard to the first electrical device 110. Because the file allocation table indicates the lists corresponding to the to-be-shared files MIF1 to MIF3, that is the access paths, the second electrical device can access the to-be-shared files according to the file allocation table via the dongle device 120. The second electrical device is substantially said legacy device. The legacy device can access the to-be-shared files selected by users and stored in remote media via the hot-plug interfaces. Moreover, the dongle device 120 can provide more functions. For example, the microcontroller 124 can decode the to-be-shared files, thus the functional requirements to the second electrical device are lowered.

The disclosure also proposes a method for file sharing. The method for file sharing includes the following steps. A file integration service program, installed in a first electrical device, is utilized to provide a file allocation table corresponding to multiple to-be-shared files accessible by the first electrical device. A hot-plug port of a dongle device is utilized to couple to a second electrical device. A microcontroller of the dongle device is utilized to disassemble and package a first instruction with a small computer system interface (SCSI) standard from the second electrical device into the first instruction with a wireless communication standard when the hot-plug port is coupled to the second electrical device. A wireless communication module of a dongle device is utilized to transmit the first instruction with the wireless communication to the first electrical device, so that the second electrical device can access the to-be-shared files according to the file allocation table via the dongle device.

The detailed principles of the above method for file sharing have been described in the system for file sharing 100 and related contents, so detailed description thereof will be omitted.

In addition, users can give a second instruction to control the dongle device 120 via the file integration service program. The wireless communication module 122 of the dongle device 120 receives the second instruction with the wireless communication standard from the first electrical device 110. The microcontroller 124 of the dongle device 120 accordingly performs corresponding operations.

The system and method for file sharing proposed in the disclosure utilize a dongle device and a file integration service program, so that legacy devices having non or limited network accessing abilities can easily access user-selected files stored in remote storage media via the dongle device.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A system for file sharing, comprising:
a file integration service program, installed in a first electrical device, for providing a file allocation table corresponding to a plurality of to-be-shared files accessible by the first electrical device; and
a dongle device, comprising:
a hot-plug port for coupling to a second electrical device;
a microcontroller for disassembling and packaging a first instruction with a small computer system interface (SCSI) standard from the second electrical device into the first instruction with a wireless communication standard when the hot-plug port is coupled to the second electrical device; and
a wireless communication module for transmitting the first instruction with the wireless communication to the first electrical device, so that the second electrical device can access the to-be-shared files via the dongle device.

2. The system for file sharing according to claim 1, wherein the to-be-shared files are stored in a local storage media, a cloud storage media or a network streaming media.

3. The system for file sharing according to claim 1, wherein the file integration service program takes a play list control program as a kernel to select the to-be-shared files according to a user application and to map the to-be-shared files and corresponding lists to the file allocation table.

4. The system for file sharing according to claim 1, wherein the file allocation table is a virtual storage image.

5. The system for file sharing according to claim 1, wherein the hot-plug port is an universal serial bus (USB) port or a 1394 port.

6. The system for file sharing according to claim 1, wherein the microcontroller is further for decoding the to-be-shared files.

7. The system for file sharing according to claim 1, wherein the file integration service program is further for sending out a second instruction to control the dongle device.

8. The system for file sharing according to claim 7, wherein the wireless communication module receives the second instruction with the wireless communication standard from the first electrical device, so that the dongle device accordingly performs corresponding operations.

9. A method for file sharing, comprising:
utilizing a file integration service program, installed in a first electrical device, to provide a file allocation table corresponding to a plurality of to-be-shared files accessible by the first electrical device;
utilizing a hot-plug port of a dongle device to couple to a second electrical device;
utilizing a microcontroller of the dongle device to disassemble and package a first instruction with a small computer system interface (SCSI) standard from the second electrical device into the first instruction with a wireless communication standard when the hot-plug port is coupled to the second electrical device;
utilizing a wireless communication module of the dongle device to transmit the first instruction with the wireless communication to the first electrical device, so that the second electrical device can access the to-be-shared files via the dongle device.

10. The method for file sharing according to claim 9, wherein the to-be-shared files are stored in a local storage media, a cloud storage media or a network streaming media.

11. The method for file sharing according to claim 9, further comprising:
utilizing a play list control program as a kernel of the file integration service program to select the to-be-shared files according to a user application and to map the to-be-shared files and corresponding lists to the file allocation table.

12. The method for file sharing according to claim 11, wherein the file allocation table is a virtual storage image.

13. The method for file sharing according to claim 9, wherein the hot-plug port is an universal serial bus (USB) port or a 1394 port.

14. The method for file sharing according to claim 9, further comprising:
utilizing the microcontroller to decode the to-be-shared files.

15. The method for file sharing according to claim 9, further comprising:
utilizing the file integration service program to send out a second instruction to control the dongle device.

16. The method for file sharing according to claim 15, further comprising:
utilizing the wireless communication module to receive the second instruction with the wireless communication standard from the first electrical device; and
utilizing the microcontroller to receive the second instruction, so that the dongle device accordingly performs corresponding operations.
